(19) United States
(12) Patent Application Publication
(10) Pub. No.: US 2022/0155096 A1
(43) Pub. Date: May 19, 2022

(54) PROCESSING SPARSE TOP-DOWN INPUT REPRESENTATIONS OF AN ENVIRONMENT USING NEURAL NETWORKS

(71) Applicant: Waymo LLC, Mountain View, CA (US)

(72) Inventors: Jinkyu Kim, Albany, CA (US); Reza Mahjourian, Austin, TX (US); Scott Morgan Ettinger, San Carlos, CA (US); Brandyn Allen White, Mountain View, CA (US); Benjamin Sapp, Marina del Rey, CA (US)

(21) Appl. No.: 17/527,676

(22) Filed: Nov. 16, 2021

Related U.S. Application Data
(60) Provisional application No. 63/114,488, filed on Nov. 16, 2020.

(51) Int. Cl. G01C 21/00; G06N 3/04; G06N 3/08

(52) U.S. Cl. CPC G01C 21/3811; G01C 21/3841; G06N 3/08; G06N 3/04

(57) ABSTRACT

Methods, computer systems, and apparatus, including computer programs encoded on computer storage media, for generating a prediction that characterizes an environment. The system obtains an input including data characterizing observed trajectories one or more agents and data characterizing one or more map features identified in a map of the environment. The system generates, from the input, an encoder input that comprises representations for each of a plurality of points in a top-down representation of the environment. The system processes the encoder input using a point cloud encoder neural network to generate a global feature map of the environment, and processes a prediction input including the global feature map using a predictor neural network to generate a prediction output characterizing the environment.

### CROSS-REFERENCE TO RELATED APPLICATION

This application claims priority to U.S. Provisional Patent Application No. 63/114,488, filed on Nov. 16, 2020, the disclosure of which is hereby incorporated by reference in its entirety.

### BACKGROUND

This specification relates to making predictions that characterize an environment. For example, the predictions may characterize the future movement of agents in the environment.

The environment may be a real-world environment, and the agents may be, e.g., vehicles, pedestrians, or cyclists, in the environment. Predicting the future motion of agents is a task required for motion planning, e.g., by an autonomous vehicle.

Autonomous vehicles include self-driving cars, boats, and aircraft. Autonomous vehicles use a variety of onboard sensors and computer systems to detect nearby objects and use such detections to make control and navigation decisions.

Some autonomous vehicles have on-board computer systems that implement neural networks, other types of machine learning models, or both for various prediction tasks, e.g., object classification within images. For example, a neural network can be used to determine that an image captured by an onboard camera is likely to be an image of a nearby car. Neural networks, or for brevity, networks, are machine learning models that employ multiple layers of operations to predict one or more outputs from one or more inputs. Neural networks typically include one or more hidden layers situated between an input layer and an output layer. The output of each layer is used as input to another layer in the network, e.g., the next hidden layer or the output layer.

Each layer of a neural network specifies one or more transformation operations to be performed on the input to the layer. Some neural network layers have operations that are referred to as neurons. Each neuron receives one or more inputs and generates an output that is received by another neural network layer. Often, each neuron receives inputs from other neurons, and each neuron provides an output to one or more other neurons.

An architecture of a neural network specifies what layers are included in the network and their properties, as well as how the neurons of each layer of the network are connected. In other words, the architecture specifies which layers provide their output as input to which other layers and how the output is provided.

The transformation operations of each layer are performed by computers having installed software modules that implement the transformation operations. Thus, a layer being described as performing operations means that the computers implementing the transformation operations of the layer perform the operations.

Each layer generates one or more outputs using the current values of a set of parameters for the layer. Training the neural network thus involves continually performing a forward pass on the input, computing gradient values, and updating the current values for the set of parameters for each layer using the computed gradient values, e.g., using gradient descent. Once a neural network is trained, the final set of parameter values can be used to make predictions in a production system.

### SUMMARY

This specification describes methods, computer systems, and apparatus, including computer programs encoded on computer storage media, for generating a prediction that characterizes an environment. In particular, the techniques include generating a sparse top-down representation of the environment and then processing the sparse top-down representation of the environment using a neural network to generate the prediction that characterizes the environment. For example, the predictions may characterize the future movement of agents in the environment.

In one innovative aspect, this specification describes a method for performing predictions. The method is implemented by a system including one or more computers. The system obtains an input including (i) data characterizing observed trajectories for each of one or more agents in an environment up to a current time point and (ii) data characterizing one or more map features identified in a map of the environment. The system generates, from the input, an encoder input that includes representations for each of a plurality of points in a top-down representation of the environment. In particular, for each of the one or more agents, the system generates a respective set of points for each of a plurality of time points in the observed trajectory that represents the position of the agent at the respective time point, and for each map feature, the system generates a respective set of points representing the map feature. The system processes the encoder input using a point cloud encoder neural network to generate a global feature map including respective features for each of a plurality of locations in the top-down representation of the environment. The system processes a prediction input including the global feature map using a predictor neural network to generate a prediction output characterizing the environment.

In some implementations of the provided method, the prediction output includes, for each a set of agent types, a respective occupancy prediction for each of a set of future time points, wherein each occupancy prediction assigns, to each of the plurality of locations in the top-down representation of the environment, a respective likelihood that any agent of the agent type will occupy the location at the future time point.

In some implementations of the provided method, the set of agent types includes a plurality of agent types.

In some implementations of the provided method, the set of future time points includes a plurality of future time points.

In some implementations of the provided method, the prediction neural network includes a convolutional neural network.

In some implementations of the provided method, the prediction neural network includes a convolutional neural network that generates each occupancy prediction as a feature map that includes a respective likelihood score for each of the locations in the environment.

In some implementations of the provided method, the convolutional neural network includes a respective convolutional head for each of the plurality of agent types that generates the one or more occupancy prediction for the agent type.

In some implementations of the provided method, the prediction input further includes a top-down rendered binary mask depicting positions of the agents at the current time point.

In some implementations of the provided method, the prediction input is a concatenation of the top-down rendered binary mask and the global feature map.

In some implementations of the provided method, the data characterizing observed trajectories for each of one or more agents in an environment up to a current time point includes, for each of the plurality of time points in the observed trajectory, data characterizing a region of the top-down representation occupied by the agent at the time point. In generating a respective set of points for each of the plurality of time points in the observed trajectory for the agent, for each of the plurality of time points, the system samples a plurality of points from within the region occupied by the agent at the time point. The respective representation for each of the sampled points can include one or more of: coordinates of the sampled point in the top-down representation, an identifier for the time point for which the sampled point was sampled, data identifying an agent type of the agent for which the point was sampled, data characterizing a heading of the agent for which the point was sampled at the time point for which the sampled point was sampled, or data characterizing a velocity, acceleration, or both of the agent for which the point was sampled at the time point for which the sampled point was sampled.

In some implementations of the provided method, the map features include one or more road elements. In generating a respective set of points representing each of the road elements, the system samples a plurality of points from a road segment corresponding to the road element. The respective representation for each of the sampled points can include one or more of: coordinates of the sampled point in the top-down representation, an identifier for the current time point, data identifying a road element type of the road element for which the point was sampled.

In some implementations of the provided method, map features include one or more traffic lights. In generating a respective set of points representing each of the traffic lights, the system selects one or more points that are each located at a same, specified position in each lane controlled by the traffic light, wherein each of the one or more points corresponds to a respective traffic light state. The respective representation for each of the selected points can include one or more of: coordinates of the selected point in the top-down representation, data identifying the corresponding traffic light state, or an identifier for a time point at which the corresponding traffic light state was observed.

In some implementations of the provided method, in processing the encoder input, the system identifies a grid representation of the top-down representation that discretizes the top-down representation into a plurality of pillars, with each of the plurality of points being assigned to a respective one of the pillars. For each pillar, the system processes the representation of the point using a point neural network to generate an embedding of the point for each point assigned to the pillar, and aggregates the embeddings of the points assigned to the pillar to generate an embedding for the pillar.

In some implementations of the provided method, in processing the encoder input, the system further processes the embeddings for the pillars using a convolutional neural network to generate the spatial feature map.

In some implementations of the provided method, in processing the representation of the point using a point neural network to generate an embedding of the point, the system generates an augmented point that also includes data characterizing at least a distance of the point from a geometric mean of the points assigned to the pillar, and provides the augmented point as input to the point neural network.

In some implementations of the provided method, the system further processes the prediction input including the global feature map using a second predictor neural network to generate a respective trajectory prediction output for each of the one or more agents that represents a future trajectory of the agent. The system can extract agent specific features for the agent from the prediction input for each agent, processes the agent specific features using the second predictor neural network to generate the trajectory prediction output for the agent.

In some implementations of the provided method, the system further trains the prediction neural network and the point cloud encoder neural network based on a consistency between the trajectory prediction outputs and the occupancy predictions.

This specification also provides a system including one or more computers and one or more storage devices storing instructions that when executed by the one or more computers, cause the one or more computers to perform the method described above.

This specification also provides one or more computer storage media storing instructions that when executed by one or more computers, cause the one or more computers to perform the method described above.

The subject matter described in this specification can be implemented in particular embodiments so as to realize one or more of the following advantages.

Predicting the future behaviors of moving agents is essential for real-world applications such as robotics and autonomous driving. The techniques provided in this specification leverage a whole-scene model with sparse input representation by representing the environment as a point set, i.e., an unordered set of points. The whole-scene sparse input representation efficiently encodes scene inputs pertaining to all agents at once. In contrast with agent-centric models for which the computation load grows linearly with the number of agents in the scene, the whole-scene sparse input representation allows the model to efficiently scale with the number of agents, e.g., by using a fixed computation budget to handle increasing numbers of agents in the scene. This provides significant advantages for scenarios with a large number of agents in the environment, such as a busy street. Because of the point set representation of the environment, the model input is much sparser than representations generated by existing whole-scene based approaches. Further, by encoding the point set representations to describe element information and state information of the agents in a coarse spatial grid, the system captures features of the environment more efficiently and compactly than conventional image-based approaches, and thus improves the accuracy and efficiency of the prediction.

Further, in some implementations of the provided techniques, the system unifies and co-trains a trajectory prediction model and an occupancy prediction model based on a consistency measure. Enforcing the consistency between occupancy and trajectory predictions provide additional accuracy improvements on both trajectory and occupancy-based predictions.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example prediction system.

FIG. 1B illustrates an example input representation for sets of features.

FIG. 2 is a flow diagram illustrating an example process for performing prediction.

Like reference numbers and designations in the various drawings indicate like elements.

### DETAILED DESCRIPTION

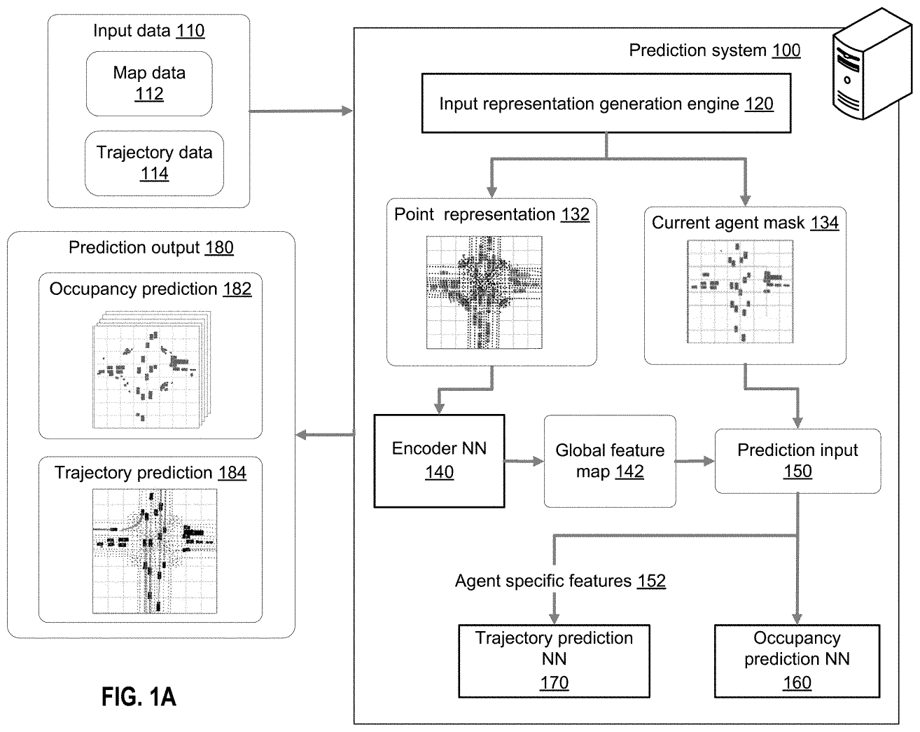

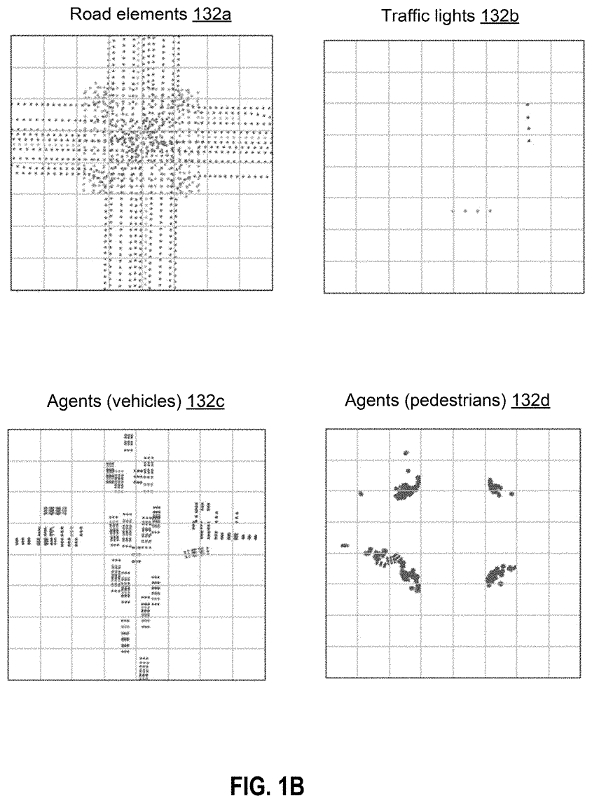

FIG. 1A shows an example of a prediction system 100 for generating a prediction that characterizes an environment. The system 100 is an example of a system implemented as computer programs on one or more computers in one or more locations, in which the systems, components, and techniques described below can be implemented.

For example, the prediction may characterize the future movements of agents in the environment. In one particular example, the prediction may be made by an onboard computer system of an autonomous vehicle navigating through the environment and the agents may be moving objects, such as other vehicles, pedestrians, and cyclists, in the environment. A planning system of the vehicle can use the likely future occupancies to make planning decisions to plan a future trajectory of the autonomous vehicle. In particular, the planning system can modify a future trajectory planned for the autonomous vehicle, for example, by submitting control inputs to a control system for the vehicle, based on the predictions, to avoid an undesirable behavior of the vehicle, such as to avoid collisions with other agents or objects in the environment.

The system 100 obtains input data 110 that includes (i) trajectory data 114 characterizing observed trajectories for each of one or more agents in an environment up to a current time point and (ii) map data 112 characterizing one or more map features identified in a map of the environment.

In some implementations, the trajectory data 114 includes, for each of a plurality of time points in the observed trajectory, data characterizing a region occupied by the agent at the time point. In some implementations, the agent trajectories are obtained from tracking or motion sensors, such as GPS sensors, accelerometers, and gyroscopes. In some other implementations, the agent trajectories can be obtained as the output of a perception system that processes sensor data, e.g., camera or LiDAR data, to detect objects in the environment.

In some implementations, the map features can include features such as lanes, crosswalks, traffic lights, and so on, identified in the map of the environment.

The system 100 includes an input representation generation engine 120 that generates an encoder input from the input data 110. The encoder input includes point representations 132 for each of a plurality of points in a top-down representation of the environment. In this specification, a top-down representation of an environment is a representation from a top-down view of the environment, e.g., centered at the current position of the autonomous vehicle. The representation for any given point generally includes the coordinates of the point in the top-down representation and other features of the point and can be, e.g., a fixed-dimensional vector of numeric values.

Concretely, for each of the one or more agents, the input representation generation engine 120 generates a respective set of points for each of the plurality of time points in the observed trajectory that represents the position of the agent at the respective time point. For each map feature, the input representation generation engine 120 generates a respective set of points representing the map feature.

In some implementations, to generate the respective set of points for each agent, for each of the plurality of time points, the input representation generation engine 120 samples a plurality of points from within the region occupied by the agent at the time point.

The respective representation for each of the sampled points for the agent can include coordinates of the sampled point in the top-down representation. The respective representation can further include one or more of: an identifier for the time point for which the sampled point was sampled, data identifying an agent type of the agent for which the point was sampled, data characterizing a heading of the agent for which the point was sampled at the time point for which the sampled point was sampled, or data characterizing a velocity, acceleration, or both of the agent for which the point was sampled at the time point for which the sampled point was sampled.

The map features can include features for one or more road elements, such as solid double yellow lanes, dotted lanes, crosswalks, speed bumps, stop/yield signs, parking lines, solid single/double lanes, road edge boundaries, and so on.

In some implementations, to generate the respective set of points representing each of the road elements, the input representation generation engine 120 samples a plurality of points from a road segment corresponding to the road element.

The respective representation for each of the sampled points for the road element can include coordinates of the sampled point in the top-down representation. The respective representation can further include one or more of: an identifier for the current time point, or data identifying a road element type of the road element.

The map features can also include one or more traffic light elements.

In some implementations, the input representation generation engine 120 can generate respective set of points representing each traffic light by selecting one or more points that are each located at a same, specified position in each lane controlled by the traffic light, where each of the one or more points corresponds to a respective traffic light state.

The respective representation for each of the selected points for the traffic light can include coordinates of the selected point in the top-down representation. The respective representation can further include data identifying the corresponding traffic light state and an identifier for a time point at which the corresponding traffic light state was observed.

In one particular example, the input representation generation engine 120 represents the top-down view of the environment as a set of points [symbol] ={pᵢ|i=1, . . . , n} with each point pᵢ being a fixed-length vector (xᵢ, yᵢ, sᵢ, qᵢ, tᵢ) where (xᵢ, yᵢ) are the 2-D coordinates of the point in the top-down coordinate system, sᵢ is a vector of dynamic state information, and qᵢ and tᵢ are one-hot vectors representing the object type and time-step index for the point, respectively.

In the particular example, the set [symbol] include three types of points: [symbol] = [symbol] ^{r}∪ [symbol] ^{tl} where [symbol] ^{r} are the road element points, [symbol] ^{a} are the agent points, and [symbol] ^{tl} represent the traffic light states.

In the particular example, road elements can be annotated either in the form of continuous curves (e.g. lanes) or polygons (e.g. regions of intersection and crosswalks) with additional attribute information like semantic labels added as annotations. The input representation generation engine 120 can represent these elements sparsely as an unordered set of points [symbol] ^{r}={pᵢ^{r}}={(xᵢ^{r}, yᵢ^{r}, sᵢ^{r}, qᵢ^{r}, tᵢ^{r})} by sampling each road segment uniformly in distance with a tunable parameter that specifies the sampling interval. The input representation generation engine 120 can set the dynamic state vector sᵢ^{r} to zero for road elements, and set the type vector qᵢ^{T} to encode the road element type (e.g., dotted lanes, crosswalks, speed bumps, stop/yield signs, parking lines, solid single/double lanes, road edge boundary, solid double yellow lanes, etc.) as a one-hot vector, and set the time index one-hot vector tᵢ^{r} is to the current time step.

For the agents, each agent at any time t can be represented by an oriented box as a tuple (xₜ, yₜ, θ_{t′}, wₜ, lₜ) where (xₜ, yₜ) denotes the agent's center position in the top-down coordinate system, θₜ denotes the heading or orientation, and wₜ and lₜ denote box dimensions. The input representation generation engine 120 can represent the agents as a set of points [symbol] ^{a}={pᵢ^{a}}={(xᵢ^{a}, yᵢ^{a}, sᵢ^{a}, qᵢ^{a}, tᵢ^{a})} by uniformly sampling coordinates (xᵢ^{a}, yᵢ^{a}) from the interior of the oriented boxes with a fixed number of samples per dimension. The agent type one-hot vector qᵢ^{a} can identify one of a set of agent types, such as: vehicles, pedestrians, or cyclists. The state vector sᵢ^{a} for all the points pᵢ^{a} sampled from an agent j at a given time step t represents a global agent state given by:

$${s}_{i}^{a} = ( cos ( {θ}_{j ( t )} ) , sin ( {θ}_{j ( t )} ) , {‖ {v}_{j ( t )} ‖}_{2} , {‖ {a}_{j ( t )} ‖}_{2} )$$

where vⱼ₍ₜ₎ and aⱼ₍ₜ₎ are the j-th agent's velocity and acceleration at time step t. The time index tᵢ^{a} is a one-hot vector representing whether the point came from the current time step or from one of a fixed number of past history steps.

In the particular example, the system 100 can generate points for traffic light states [symbol] ^{tl}={pᵢ^{tl}}={(xᵢ^{tl}, yᵢ^{ti}, sⱼ^{tl}, qᵢ^{tl}, tⱼ^{tl})} to represent dynamic road information by placing a point at the end of each traffic light controlled lane. The dynamic state vector sᵢ^{tl} for these points can specify one of: unknown, red, yellow, or green. The system can set the type vector qᵢ^{tl} to zero, and set the time index tᵢ^{tl} to encode the time step of the traffic light state.

An example input representation for these sets is illustrated in FIG. 1B, including representations for the road elements 132a, traffic lights 132b, agents (vehicles) 132c, and agents (pedestrians) 132d.

Referring back to FIG. 1A, the system 100 processes the encoder input including the point representation 132 using a point cloud encoder neural network 140 to generate a global feature map 142. The global feature map 142 includes respective features for each of a plurality of locations in the top-down representation of the environment.

In some implementations, to process the encoder input, the system 100 identifies a grid representation of the top-down representation that discretizes the top-down representation into a plurality of pillars, with each of the plurality of points being assigned to a respective one of the pillars. For each pillar and for each point assigned to the pillar, the system 100 processes the representation of the point using a point neural network of the encoder neural network 140 to generate an embedding of the point. The system aggregates the embeddings of the points assigned to the pillar to generate an embedding for the pillar. Examples of an encoder that uses a point neural network to learn a representation of point clouds organized in vertical columns (pillars) are described in “Pointpillars: Fast encoders for object detection from point clouds”, Lang, et al., arXiv:1812.05784 [cs.LG], 2018, the content of which is herein incorporated by reference.

In some implementations, in processing the representation of the point using the point neural network, the system 100 generates an augmented point that also includes data characterizing at least a distance of the point from a geometric mean of the points assigned to the pillar, and provides the augmented point as input to the point neural network.

In some implementations, the system 100 further processes the embeddings for the pillars using a convolutional neural network of the encoder neural network 140 to generate the spatial feature map.

In one particular example, the system 100 uses the point cloud encoder 140 to process a set of points [symbol] and generate the global feature map F that captures the contextual information of the elements in the environment. In the particular example, the system 100 can process of the input point set in two stages including (1) intra-voxel point encoding and (2) inter-voxel encoding.

In intra-voxel point encoding, the system 100 discretizes the point set [symbol] into an evenly spaced grid of shape M×N in the x-y plane, creating a set of MN pillars {π₁, π₂, . . . , π_{MN}}. The system then augments the points in each pillar with a tuple (x_{c}, y_{c}, x_{offset}, y_{offset}) where the c subscript denotes distance to the arithmetic mean of all points in the pillar and the offset subscript denotes the offset from the pillar x, y center. The system can then apply the point neural network to embed and aggregate points to summarize the variable number of points in each pillar πⱼ.

The point network can take any appropriate architecture. For example, the system can apply a linear fully-connected layer followed by batch normalization and a ReLU operation to encode each point. The system then applies a max operation across all the points within each pillar to provide the final scene context representation vector.

$${f}_{{π}_{j}} = MaxPool ( {\{ ReLU ( BN ( F C ( {p}_{i} ) ) ) \}}_{{p}_{i} ∈ {π}_{j}} )$$

In inter-voxel point processing, the system 100 can apply the convolutional neural network that includes two sub-networks: (1) a top-down network (e.g., with a ResNet-based architecture) that extracts a feature representation at a small spatial resolution for the whole scene to preserve spatial structure followed by (2) a deconvolution network to perform upsampling to obtain features map F that captures the environmental context and agent intent.

The system 100 processes a prediction input 150 including the global feature map 142 using an occupancy prediction neural network 160 to generate an occupancy prediction 182 as part of a prediction output 180 characterizing the environment.

In some implementations, the input representation generation engine 120 further generates a top-down rendered binary mask 134 depicting positions of the agents at the current time point. The binary mask 134 can be a two dimensional map having the value “1” for positions currently occupied by an agent and the value “0” for positions not occupied by any agent. The system 100 includes binary mask 134 in the prediction input 150.

For example, the system can generate the prediction input 150 by combining, e.g., by concatenating, the global feature map 142 with the binary mask 134.

The occupancy prediction 182 includes, for each of a set of one or more agent types, a respective occupancy prediction for each of a set of future time points. Each occupancy prediction assigns, to each of the plurality of locations in the top-down representation of the environment, a respective likelihood that any agent of the agent type will occupy the location at the future time point.

In some implementations, the occupancy prediction neural network 160 includes a convolutional neural network. The convolutional neural network can be configured to generate each occupancy prediction as a feature map that includes a respective likelihood score for each of the locations in the environment.

In some implementations, the convolutional neural network can include a respective convolutional head for each of the plurality of agent types that generates the one or more occupancy predictions for the agent type.

In one particular example, the system uses the occupancy prediction neural network 160 to process an input including the concatenation of the top-down rendered binary mask 134 and the global feature map 142, and generates output probability heatmaps that indicate agent bounding box occupancy Gₜ^{a} for each agent type a∈{vehicle, pedestrian} at timestep t∈(0, T]. That is, for both the “vehicle” and the “pedestrian” agent types, the system generates a respective heatmap for each time step from 1 to T, with the heatmap for time t for the “vehicle” agent type including a respective probability for each of the locations in the environment that represents the predicted probability that a vehicle will be located at that location at time t and the heatmap for time t for the “pedestrian” agent type including a respective probability for each of the locations in the environment that represents the predicted probability that a pedestrian will be located at that location at time t.

In the particular example, the occupancy prediction neural network can include a convolutional neural network followed by a deconvolution network that outputs the future agent bounding box heatmaps. The system can apply a per-pixel sigmoid activation to represent the probability that the agent occupies a particular pixel.

In some implementations, the system 100 further processes the prediction input 150 using a trajectory prediction neural network 170 to generate a respective trajectory prediction output 184 for each of the one or more agents that represents a future trajectory of the agent.

In some implementations, in processing the prediction input using the trajectory prediction neural network 170, for each agent, the system extracts agent specific features for the agent from the prediction input 150, for example, by processing the prediction input 150 using one or more neural network layers, and processes the agent specific features using the trajectory prediction neural network 170 to generate the trajectory prediction output for the agent.

The predictions generated by networks 160 and 170 can complement each other for specific applications. The occupancy prediction neural network 160 uses a fixed compute budget that is independent of the number of agents to estimate regions of space that the agents could occupy at discrete future time steps. The model implicitly learns to be aware of joint physical consistency between all pairs of agents, i.e. multiple agents cannot occupy the same location at a given time. The trajectory prediction neural network 170 directly produces potential trajectories of a specific agent. Such predictions can be readily used for making certain types of planning decisions with respect to specific agents in the scene.

The trajectory prediction neural network 170 can take any appropriate architecture. In one particular example, the system 100 uses a MultiPath prediction network that predicts a discrete distribution over a fixed set of future state-sequence anchors and, for each anchor, regresses offsets from anchor waypoints along with uncertainties at each time step, and generates agent specific trajectory predictions. An example technique for the MultiPath prediction is described in “MultiPath: Multiple Probabilistic Anchor Trajectory Hypotheses for Behavior Prediction,” Chai, et al., arXiv:1910.05449 [cs.LG], 2019, the content of which is incorporated by reference herein.

Prior to using the neural network described above, i.e., a neural network that includes the neural networks 140, 160, and 170, to generate the prediction output, the system 100 or another system can perform training of the neural network using training examples. Each training example can include map data and agent trajectory data up to a specific time point as input of the neural network, as well as a ground-truth label of the prediction output, including, e.g., the occupancy and trajectories of the agents after the specific time point. The training system can update network parameters of the neural network in the system 100 using any appropriate optimizer for neural network training, e.g., SGD, Adam, or rmsProp, to minimize a loss [symbol] computed based on the prediction output generated by the network and the ground-truth label.

In some implementations, the loss L includes an occupancy loss [symbol] _{g} computed at the output of the occupancy prediction network 160. In a particular example, [symbol] _{g} is computed at the respective outputs of the respective convolutional heads of the occupancy prediction network for each agent type a as:

$${ℒ}_{g} ( G , {G}^{gt} ) = \frac{1}{WH} {\sum }_{a} {\sum }_{t} {\sum }_{x} {\sum }_{y} ℋ ( {G}_{t}^{a} , {G}_{t}^{a , gt} ) ,$$

which measures the cross-entropy loss between the predicted occupancy grids Gₜ^{a} and the ground-truth Gₜ^{a,gt} for time step t∈(0, T], where Gₜ^{a,gt} is an image where the agents are rendered as oriented rectangular binary masks. [symbol] denotes the cross-entropy function. W and H are dimensions of the output prediction map, and x and y are positions on the output prediction map.

In some implementations, the loss L includes a trajectory loss computed at the trajectory prediction neural network 170. In an example, the trajectory loss includes a sum of cross-entropy classification loss over anchors [symbol] ₛ (where the ground-truth trajectories are assigned an anchor via closest Euclidean distance) and a within-anchor regression loss [symbol] ᵣ. An example for computing the trajectory loss is described in “MultiPath: Multiple Probabilistic Anchor Trajectory Hypotheses for Behavior Prediction,” Chai, et al., arXiv:1910.05449 [cs.LG], 2019.

In some implementations, the loss [symbol] further includes a consistency loss [symbol] _{c} measuring an inconsistency between the trajectory prediction outputs and the occupancy predictions. In an example, the training system can render one or more trajectory predictions into binary maps Gₜ′^{a} for each future time step, and compute the consistency loss with the occupancy outputs Gₜ^{a} as a cross-entropy loss:

$${ℒ}_{C} ( G , {G}^{f} ) = \frac{1}{WH} {\sum }_{a} {\sum }_{t} {\sum }_{x} {\sum }_{y} ℋ ( {G}_{t}^{a} , {G}_{t}^{ta} )$$

By enforcing consistency between the occupancy prediction and the trajectory prediction at training, the prediction accuracy can be further improved.

In some implementations, the total loss is computed as a weighted sum of the loss terms described above, as [symbol] =λ_{g} [symbol] _{g}+λₛ [symbol] ₛ+λᵣ [symbol] ᵣ+λ_{c} [symbol] _{c}, where λ_{g}λₛ, λᵣ, and λ_{c} are chosen to balance the training process.

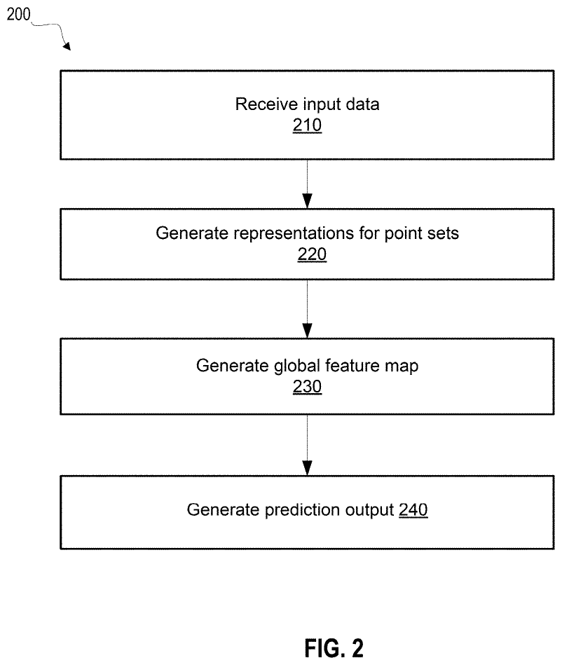

FIG. 2A is a flow diagram illustrating an example process 200 for performing a prediction that characterizes an environment. For convenience, the process 200 will be described as being performed by a system of one or more computers located in one or more locations. For example, a prediction system, e.g., the prediction system 100 of FIG. 1A, appropriately programmed in accordance with this specification, can perform the process 200.

In step 210, the system receives input data. The input data includes (i) data characterizing observed trajectories for each of one or more agents in an environment up to a current time point and (ii) data characterizing one or more map features identified in a map of the environment.

In some implementations, the data characterizing the observed trajectories for the agents includes, for each of a plurality of time points in the observed trajectory, data characterizing a region of the top-down representation occupied by the agent at the time point.

In step 220, the system generates an encoder input from the input data. The encoder input includes representations for each of a plurality of points in a top-down representation of the environment. Concretely, for each of the one or more agents, the system generates a respective set of points for each of the plurality of time points in the observed trajectory that represents the position of the agent at the respective time point. For each map feature, the system generates a respective set of points representing the map feature.

In some implementations, to generate the respective set of points for each agent, for each of the plurality of time points, the system samples a plurality of points from within the region occupied by the agent at the time point.

The respective representation for each of the sampled points for the agent can include coordinates of the sampled point in the top-down representation. The respective representation can further includes one or more of: an identifier for the time point for which the sampled point was sampled, data identifying an agent type of the agent for which the point was sampled, data characterizing a heading of the agent for which the point was sampled at the time point for which the sampled point was sampled, or data characterizing a velocity, acceleration, or both of the agent for which the point was sampled at the time point for which the sampled point was sampled.

The map features can include features for one or more road elements and one or more traffic lights.

In some implementations, to generate the respective set of points representing each of the road elements, the system samples a plurality of points from a road segment corresponding to the road element.

The respective representation for each of the sampled points for the road element can include coordinates of the sampled point in the top-down representation. The respective representation can further includes one or more of: an identifier for the current time point, or data identifying a road element type of the road element for which the point was sampled.

In some implementations, the system can generate respective set of points representing each traffic light by selecting one or more points that are each located at a same, specified position in each lane controlled by the traffic light, where each of the one or more points corresponds to a respective traffic light state.

The respective representation for each of the selected points for the traffic light can include coordinates of the selected point in the top-down representation. The respective representation can further include data identifying the corresponding traffic light state and an identifier for a time point at which the corresponding traffic light state was observed.

In step 230, the system processes the encoder input using a point cloud encoder neural network to generate a global feature map. The global feature map includes respective features for each of a plurality of locations in the top-down representation of the environment.

In some implementations, to process the encoder input, the system identifies a grid representation of the top-down representation that discretizes the top-down representation into a plurality of pillars, with each of the plurality of points being assigned to a respective one of the pillars. For each pillar and for each point assigned to the pillar, the system processes the representation of the point using a point neural network to generate an embedding of the point, and aggregates the embeddings of the points assigned to the pillar to generate an embedding for the pillar.

In some implementations, in processing the representation of the point using the point neural network, the system generates an augmented point that also includes data characterizing at least a distance of the point from a geometric mean of the points assigned to the pillar, and provides the augmented point as input to the point neural network.

In some implementations, the system further processes the embeddings for the pillars using a convolutional neural network to generate the spatial feature map.

In step 240, the system processes a prediction input including the global feature map using a predictor neural network (i.e., an occupancy prediction neural network) to generate a prediction output characterizing the environment.

In some implementations, the prediction output includes, for each of a set of one or more agent types, a respective occupancy prediction for each of a set of future time points. Each occupancy prediction assigns, to each of the plurality of locations in the top-down representation of the environment, a respective likelihood that any agent of the agent type will occupy the location at the future time point.

In some implementations, the prediction neural network includes a convolutional neural network.

In some implementations, the convolutional neural network generates each occupancy prediction as a feature map that includes a respective likelihood score for each of the locations in the environment.

In some implementations, the convolutional neural network can include a respective convolutional head for each of the plurality of agent types that generates the one or more occupancy prediction for the agent type.

In some implementations, the prediction input further includes the top-down rendered binary mask depicting positions of the agents at the current time point.

In some implementations, the prediction input is a concatenation of the top-down rendered binary mask and the global feature map.

In some implementations, the system further processes the prediction input including the global feature map using a second predictor neural network (i.e., a trajectory prediction neural network) to generate a respective trajectory prediction output for each of the one or more agents that represents a future trajectory of the agent.

In some implementations, in processing the prediction input using the second predictor neural network, for each agent, the system extracts agent specific features for the agent from the prediction input, and processes the agent specific features using the second predictor neural network to generate the trajectory prediction output for the agent.

In some implementations, the system further trains the prediction neural network and the point cloud encoder neural network based on a consistency between the trajectory prediction outputs and the occupancy predictions.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving an input including (i) data characterizing observed trajectories for each of one or more agents in an environment up to a current time point and (ii) data characterizing one or more map features identified in a map of the environment;
generating, from the input, an encoder input that comprises representations for each of a plurality of points in a top-down representation of the environment, comprising:
for each of the one or more agents, generating a respective set of points for each of a plurality of time points in the observed trajectory that represents the position of the agent at the respective time point, and
for each map feature, generating a respective set of points representing the map feature;
processing the encoder input using a point cloud encoder neural network to generate a global feature map comprising respective features for each of a plurality of locations in the top-down representation of the environment; and
processing a prediction input comprising the global feature map using a predictor neural network to generate a prediction output characterizing the environment.

2. The method of claim 1, wherein the prediction output comprises, for each of a set of one or more agent types, a respective occupancy prediction for each of a set of future time points, wherein each occupancy prediction assigns, to each of the plurality of locations in the top-down representation of the environment, a respective likelihood that any agent of the agent type will occupy the location at the future time point.

3. The method of claim 2, wherein the set of agent types includes a plurality of agent types.

4. The method of claim 3, wherein the prediction neural network comprises a convolutional neural network that generates each occupancy prediction as a feature map that includes a respective likelihood score for each of the locations in the environment.

5. The method of claim 4, wherein the convolutional neural network comprises a respective convolutional head for each of the plurality of agent types that generates the one or more occupancy prediction for the agent type.

6. The method of claim 1, wherein the prediction input further comprises a top-down rendered binary mask depicting positions of the agents at the current time point.

7. The method of claim 1, wherein:
the data characterizing observed trajectories for each of one or more agents in an environment up to a current time point comprises, for each of the plurality of time points in the observed trajectory, data characterizing a region of the top-down representation occupied by the agent at the time point, and
generating a respective set of points for each of a plurality of time points in the observed trajectory for the agent that represent the position of the agent at the respective time point comprises, for each of the plurality of time points:
sampling a plurality of points from within the region occupied by the agent at the time point.

8. The method of claim 7, wherein the respective representation for each of the sampled points comprises:
an identifier for the time point for which the sampled point was sampled.

9. The method of claim 7, wherein the respective representation for each of the sampled points comprises:
data identifying an agent type of the agent for which the point was sampled.

10. The method of claim 7, wherein the respective representation for each of the sampled points comprises:
data characterizing a heading of the agent for which the point was sampled at the time point for which the sampled point was sampled.

11. The method of claim 1, wherein the map features comprise one or more road elements, and wherein generating a respective set of points representing each of the road elements comprises:
sampling a plurality of points from a road segment corresponding to the road element.

12. The method of claim 1, wherein the map features comprise one or more traffic lights, and wherein generating a respective set of points representing each of the traffic lights comprises:
selecting one or more points that are each located at a same, specified position in each lane controlled by the traffic light, wherein each of the one or more points corresponds to a respective traffic light state.

13. The method of claim 1, wherein processing the encoder input comprises: identifying a grid representation of the top-down representation that discretizes the top—
down representation into a plurality of pillars, with each of the plurality of points being assigned to a respective one of the pillars;
for each pillar:
for each point assigned to the pillar, processing the representation of the point using a point neural network to generate an embedding of the point; and
aggregating the embeddings of the points assigned to the pillar to generate an embedding for the pillar.

14. The method of claim 13, wherein processing the encoder input further comprises:
processing the embeddings for the pillars using a convolutional neural network to generate the spatial feature map.

15. The method claim 13, wherein processing the representation of the point using a point neural network to generate an embedding of the point comprises:
generating an augmented point that also includes data characterizing at least a distance of the point from a geometric mean of the points assigned to the pillar; and
providing the augmented point as input to the point neural network.

16. The method of claim 2, further comprising:
processing the prediction input comprising the global feature map using a second predictor neural network to generate a respective trajectory prediction output for each of the one or more agents that represents a future trajectory of the agent.

17. The method of claim 16, wherein the processing comprises:
for each agent, extracting agent specific features for the agent from the prediction input; and
processing the agent specific features using the second predictor neural network to generate the trajectory prediction output for the agent.

18. The method claim 16, further comprising:
training the prediction neural network and the point cloud encoder neural network based on a consistency between the trajectory prediction outputs and the occupancy predictions.

19. A system comprising:
one or more computers; and
one or more storage devices storing instructions that, when executed by the one or more computers, cause the one or more computers to perform:
receiving an input including (i) data characterizing observed trajectories for each of one or more agents in an environment up to a current time point and (ii) data characterizing one or more map features identified in a map of the environment;
generating, from the input, an encoder input that comprises representations for each of a plurality of points in a top-down representation of the environment, comprising:
for each of the one or more agents, generating a respective set of points for each of a plurality of time points in the observed trajectory that represents the position of the agent at the respective time point, and
for each map feature, generating a respective set of points representing the map feature;
processing the encoder input using a point cloud encoder neural network to generate a global feature map comprising respective features for each of a plurality of locations in the top-down representation of the environment; and
processing a prediction input comprising the global feature map using a predictor neural network to generate a prediction output characterizing the environment.

20. One or more computer-readable storage media storing instructions that when executed by one or more computers cause the one or more computers to perform:
receiving an input including (i) data characterizing observed trajectories for each of one or more agents in an environment up to a current time point and (ii) data characterizing one or more map features identified in a map of the environment;
generating, from the input, an encoder input that comprises representations for each of a plurality of points in a top-down representation of the environment, comprising:
for each of the one or more agents, generating a respective set of points for each of a plurality of time points in the observed trajectory that represents the position of the agent at the respective time point, and
for each map feature, generating a respective set of points representing the map feature;
processing the encoder input using a point cloud encoder neural network to generate a global feature map comprising respective features for each of a plurality of locations in the top-down representation of the environment; and
processing a prediction input comprising the global feature map using a predictor neural network to generate a prediction output characterizing the environment.
